(19) United States
(12) Patent Application Publication
(10) Pub. No.: US 2001/0047642 A1
(43) Pub. Date: Dec. 6, 2001

(54) OPERATOR CONTROL SYSTEM FOR A WALK-BEHIND MACHINE AND METHOD FOR USING USING SAME

(76) Inventors: WILLIAM D. KENT, BELLEVUE, WA (US); JAMES R. BAUMANN, ST. LOUIS PARK, MN (US)

Correspondence Address: SCHWEGMAN, LUNDBERG, WOESSNER & KLUTH, P.A., 1600 TCF TOWER, 121 SOUTH 8TH STREET, MINNEAPOLIS, MN, 55402, US

(21) Appl. No.: 09/386,326

(22) Filed: Aug. 30, 1999

(51) Int. Cl. A01D 69/00

(52) U.S. Cl. 56/16.7

(57) ABSTRACT

One aspect of the present invention is directed to an improved operator control system for a walk-behind, mid-size mower having a prime mover and two or more ground-engaging traction wheels. The control system includes a handle having a hand grip and an upper control lever wherein the latter permits engagement of one or both traction wheels for forward or reverse motion and turning. The system further includes a lower lever easily accessible by one or both hands from the hand grip. The lower lever is coupled to the upper control lever such that squeezing the lower lever towards the hand grip also engages both traction wheels. In addition, when the lower lever is squeezed toward the hand grip, it is then substantially adjacent thereto. This permits the operator to provide better lifting assistance to the mower during curb traversal while maintaining engagement of the drive wheels. Further, the proximity of the lower lever to the handle permits the operator to engage the lever with one hand during reverse operation, permitting the operator to face away from the mower when in reverse.

### TECHNICAL FIELD

This invention relates generally to a self-propelled ground engaging machine and, more particularly, to an improved control system for a walk-behind, mid-size lawn mower.

### BACKGROUND OF THE INVENTION

Many types of lawn mowing equipment are known. To mow smaller areas such as residential yards and the like, small push-type or self-propelled mowers are common. These mowers typically utilize cutting decks ranging from approximately 18-22 inches in width. For more substantial acreage, conventional riding mowers are more prevalent. Riding mowers typically include cutting decks ranging in width from approximately 30-60 inches or larger. Due to their size and limited maneuverability though, conventional riding mowers are best suited for mowing large, relatively unobstructed areas. The need to efficiently mow large areas having numerous obstacles thus remains.

One machine that satisfies this need is a highly-maneuverable riding mower such as a “zero-turn-radius” mower of the type generally represented by the Z-MASTER™ 300 Series sold by The Toro Company; assignee herein. Another category of mowers that addresses this need is mid-size, walk-behind mowers. Mid-size mowers provide the agility and maneuverability of their smaller counterparts while having the driving power and cutting unit sizes more commonly associated with riding mowers. In addition, because they are less complicated, walk-behind mowers are generally less expensive than conventional and “zero-turn” riders. The present invention is directed to a mid-size, walk-behind mower (hereinafter “mid-size mower”) and the remainder of this discussion will focus accordingly.

Mid-size mowers are typically available in both hydraulic drive and gear drive configurations. Hydraulic drive configurations utilize a hydraulic pump to drive independent hydraulic motors operatively coupled to the axle of each drive wheel. Gear drive units, on the other hand, utilize a transmission having a gear selector which determines the output drive shaft speed and direction. The drive shaft typically drives at least two drive wheels via separate chains or, more commonly, belts. A biased, tensioning device such as an idler pulley selectively places tension on the belt and permits the operator to engage the drive wheels independently. By engaging both drive wheels, the mower may be moved in the forward or reverse direction (depending on the gear selected). By engaging only one drive wheel, the operator may initiate a turn. While the instant invention is applicable to both hydraulic and gear drive machines, it is perceived to be particularly beneficial to the latter and will, for the sake of brevity, be described with respect to the same.

To control the movement of the machine, many mid-size mowers use two handles equipped with squeeze-type levers. The levers control two driving wheels typically mounted at the rear comers of the cutting unit. When the mower is shifted into gear, it moves in the selected direction. To execute a turn, one of the levers is pressed to either engage a brake or, alternatively, to overcome the bias on the idler pulley, thus removing tension from the drive belt and disengaging the driving power to that wheel. The other wheel continues to drive, thus causing the mower to turn. This type of control could be characterized as “normally engaged” since it is engaged unless shifted out of gear (or both levers are pressed simultaneously). Other lever configurations may operate as “normally disengaged” systems (e.g., squeeze lever in order to engage).

Because the biasing force of the idler pulley against the drive belt is great, it takes considerable force to squeeze the levers and disengage the drive system. As such, when cutting lawns with numerous or intricate obstacles (e.g., trees, shrubs, gardens, and the like), the operator's hands, wrists and arms experience significant fatigue.

One machine which overcomes this and other problems inherent with conventional, mid-size mower controls is described in U.S. Pat. No. 4,558,558 (issued to Horner and assigned to the assignee herein) which is incorporated herein by reference in its entirety. Horner describes a mower having a U-shaped handle extending from the mower body. A “T-bar” control system is mounted to the handle and is pivotable about a generally horizontal axis transverse to the mower. By selecting a forward gear and pushing the T-bar forward, linkages attached between the T-bar and each idler pulley engage the respective drive belts and thus drive each wheel. The T-bar is further pivotable about a central axis generally perpendicular to the horizontal axis. By pivoting about the central axis, the T-bar can individually engage the linkage on one side of the mower independently of the opposite side. That is, the idler pulley of one drive wheel may be selectively engaged, causing the mower to turn. The geometry of the T-bar provides significant mechanical advantage which allows extended operation of the machine without the operator fatigue commonly experienced with squeeze-type control levers.

As shown in FIG. 6, Homer further describes a reverse bail 602 extending downwardly from the underside of the handle generally in the plane of the T-bar lever. The lower bail is used for reverse operation (i.e., when the gear selector is in reverse). In particular, pivoting of the lower bail 602 rearwardly causes the T-bar 601 to pivot forwardly, thus engaging both idler pulleys. The lower bail is advantageous because it allows the operator to move the bail rearwardly in order to move the mower rearwardly. Stated alternatively, when the gear selector is in reverse, the operator may back up by pulling the lower bail rearwardly. In this way, the control system operates intuitively and in conformance with industry standards.

While the T-bar/reverse bail control system provides greatly improved operator control, problems remain. One such problem occurs when traversing obstacles such as curbs. Due to their configuration and weight distribution, mid-sized mowers are generally perceived to be more easily backed over ground obstructions (as opposed to forward traversal). Even when traversing obstacles in reverse though, mid-size mowers require substantial operator assistance. For example, when traversing a curb in reverse, the mower is backed up until the drive wheels make contact with the curb. At that point, the operator must lift upwardly on the handle 604 to assist the drive wheels in climbing the curb. Similar assistance is needed when traversing in a forward direction. While pushing or lifting the handle, the T-bar (or reverse bail) must remain engaged so that the driving force to each drive wheel is maintained. This combination of T-bar (or reverse bail) engagement and handle lifting/pushing necessitates that the operator generally hold the T-bar (or bail) with one hand while lifting/pushing the primary handle with the other. Although this hand position is more than adequate for mower control, it is somewhat awkward for lifting and pushing. Furthermore, since neither the T-bar nor the lower bail are geometrically positioned or structurally adapted to resist lifting/pushing loads, the operator is oftentimes limited to lifting/pushing with only the one hand located on the handle 604.

Another problem with the T-bar control system occurs during normal reverse operation. Because the operator must keep one hand on the handle and one hand on the controls as shown in FIG. 6, the operator is required to maintain a substantially forward-facing stance even when operating in reverse. While safe, it is generally thought to be more convenient to swivel and partially face the direction of travel when moving in reverse.

Accordingly, what is needed is an operator control system for a mid-size mower that assists in climbing curbs and other obstacles. What is further needed is an operator control system that provides improved reverse operation while maintaining conformance with industry standards. The present invention addresses these needs.

### SUMMARY OF THE INVENTION

To address these and other issues, an improved operator control system was devised. In one embodiment, an operator control system for use with a self-propelled machine is provided where the machine has a prime mover selectively coupled to two or more ground-engaging traction wheels. The system includes a handle attached to the machine where the handle extends in a generally rearwardly direction. The handle further forms a transverse hand grip, wherein the hand grip is adapted to receive one or both hands of an operator. The system additionally includes a pivot member transversely and pivotally mounted to the handle, where the pivot member has a pivot axis substantially parallel with the hand grip. A first lever positioned above the handle is also provided. The first lever has a downwardly extending connecting member operatively coupled to the pivot member. The first lever is pivotable about the pivot axis between a neutral position and an operating position. The system further includes a second lever attached to the pivot member and extending downwardly and away therefrom. The second lever is movable from a first position in which the second lever extends at an acute angle from the handle, to a second position in which the second lever is substantially adjacent to the hand grip. The operator may manipulate the second lever between the first and second positions with the one or both hands while the one or both hands are positioned on the hand grip.

In another embodiment, a method for transporting a self-propelled, walk-behind machine rearwardly over a ground obstruction is provided where the machine has a prime mover selectively coupled to two or more traction wheels. The method includes providing an operator control system having a handle attached to the machine and extending in a generally upwardly and rearwardly direction. The handle forms a transverse hand grip wherein the hand grip is adapted to receive one or both hands of an operator. The system further includes a pivot member transversely and pivotally mounted to the handle where the pivot member has a pivot axis generally parallel with the hand grip; and a first lever positioned above the handle where the first lever has a downwardly extending connecting member operatively coupled to the pivot member. A second lever is also provided which is attached to the pivot member and extends downwardly and away therefrom, the second lever being movable from a first position in which the second lever extends at an acute angle from the handle, to a second position in which the second lever is in close proximity to the hand grip. The operator may manipulate the second lever between the first and second positions with the one or both hands while the one or both hands are positioned on the hand grip. The method also includes grasping the hand grip and squeezing the second lever thereto, thereby engaging the prime mover with the traction wheels to propel the machine in reverse. Once the obstruction is contacted with the traction wheels; the method includes lifting upwardly on the hand grip and the second lever with the one or both hands to assist the machine as it traverses the obstruction.

Advantageously, the control system of the present invention provides improved operator control, particularly for reverse operation and curb traversal. By providing a lower lever which is conveniently accessible with one or both hands while the one or both hands are on the mower hand grip, the operator is able to maintain engagement of the drive system while maintaining a secure grip on the hand grip. Accordingly, the operator can more easily provide assistance to the mower during obstacle traversal. Furthermore, the geometry of the lower lever permits the operator to hold the lever engaged with one hand, therefore permitting the operator to swivel his or her body during reverse operation. Additionally, the present invention allows straight line, forward travel by permitting forward engagement of the drive system with the lower lever.

### BRIEF DESCRIPTION OF THE DRAWINGS

The invention described herein will be further characterized with reference to the drawings, wherein:

FIG. 1 is a right front perspective view of a mid-size mower in accordance with one embodiment of the invention;

FIG. 2 is an enlarged right rear perspective view of the mower of FIG. 1 illustrating a control system in accordance with one embodiment of the invention;

FIG. 3 is a side elevation view of the control system of FIG. 2 illustrating the control system in a neutral position;

FIG. 4 is a side elevation view of the control system of FIG. 2 illustrating the control system in an engaged or operating position;

FIGS. 5A-5B are diagrammatic views of the mower in accordance with one embodiment of the invention as it traverses a curb; and

FIG. 6 is a side elevation view of a conventional T-bar/reverse bail mower control.

### DETAILED DESCRIPTION OF THE EMBODIMENTS

In the following detailed description of the embodiments, reference is made to the accompanying drawings which form a part hereof, and in which are shown by way of illustration specific embodiments in which the invention may be practiced. It is to be understood that other embodiments may be utilized and structural changes may be made without departing from the scope of the invention.

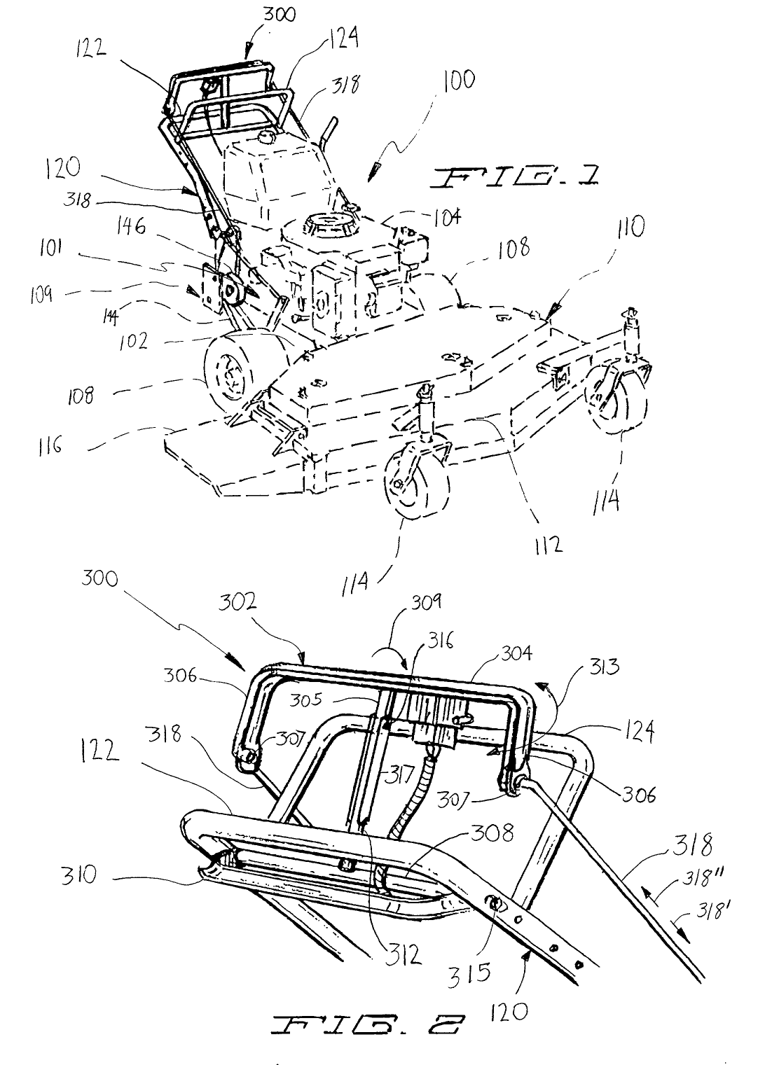

Referring to the Drawings, wherein like reference numerals designate like parts and assemblies throughout the several views, FIG. 1 shows a perspective view of a walk-behind machine which, in accordance with one embodiment of the invention, is a mid-size mower 100 similar to the type represented by the PROLINE gear-drive mid-size mower sold by The Toro Company, assignee herein. Those skilled in the art will realize, however, that the present invention could be applied to other types of mowers and even other types of self-propelled, ground engaging machines. Thus, the embodiments described herein are exemplary only and are not intended to limit the scope of the invention in any way.

Although the general construction of the mower 100 is, for the most part, not central to the invention, the basic components will be described with reference to FIG. 1. The mower 100 comprises a frame 102 which supports a drive system 101 having a prime mover, which is typically an internal combustion engine 104, and a transmission (not shown). The transmission is operatively coupled to two or more ground-engaging traction wheels 108. The frame 102 further supports a ground-engaging implement such as a cutting unit 110 having a housing 112 and one or more cutting elements or blades (not shown). The cutting unit 110 is, in one embodiment, rigidly or semi-rigidly attached to the forward portion of the frame 102 (see FIG. 1). Supporting the front of the cutting unit 110 are a pair of vertically-adjustable caster wheels 114. In another embodiment, the frame has forwardly extending frame rails (not shown) supported by a pair of front caster wheels wherein the cutting unit 110 hangs or “floats” from the frame rails. The cutting unit may further include a side discharge chute 116 for discharging grass clippings.

A rearwardly extending gear selector (not shown) allows the operator to adjust the transmission output between neutral, one or more forward gears, and one or more reverse gears. The mower further includes drive system 101 for receiving driving power from the prime mover 104 and transmission and transferring it to the traction wheels 108. The drive system comprises a separate drive mechanism 109 to selectively transfer drive power from an output shaft (not shown) of the transmission to each traction wheel 108 (for simplicity, the following discussion makes frequent reference to the drive mechanism 109 in the singular; however, a separate mechanism exists for each traction wheel 108). The drive mechanism 109, in one embodiment, comprises one or more idler pulleys 146 which are capable of engaging a friction drive belt 144 (see FIG. 1) in proportional response to operator input commands. Other drive means including chain drives, hydraulic motors and the like are also within the scope of the invention.

Extending upwardly and outwardly from the rear of the frame 102 is a handle 120. Referring to FIGS. 1 and 2, the handle 120 is U-shaped wherein the open end attaches to the frame 102 and the transverse end forms an operator hand grip 122. The handle 120 further supports a hand rest 124 and other components that form part of a control system 300 which is further described below. Various controls such as throttle control, engine on/off switch, blade control switch and others (none of which are shown) are also located on the handle 120. During operation, the operator walks behind the mower such that the control system 300, gear selector, and other operator controls are easily accessible. In one embodiment, a seat-attachment or “sulky” is attached to the rear of the mower 100 so that the operator may ride instead of walk.

Having described the mower 100 generally, attention is now directed to the operator control system 300 in accordance with one embodiment of the invention. Referring first to FIG. 2, the control system 300 comprises a first or upper control lever 302 having a generally horizontal or transverse portion 304. The lever 302 further has transverse ends 306 extending downwardly at approximately 90 degrees to the transverse portion 304. A centrally located connecting member comprising a hollow tube 305 is rigidly attached to the transverse portion 304 and extends downwardly generally in the same plane as the ends 306.

Still referring to FIG. 2, a pivot member or shaft 308 is pivotally and transversely attached to the handle 120 proximal the hand grip 122 about a pivot axis 315. Extending from the shaft 308 is a second or lower lever 310, described in more detail below, and a central stem 312, the latter protruding upwardly in a direction generally coaxial with the hollow tube 305. The stem 312 has diametrically opposed slotted holes (not shown) near its upper end which are aligned in a plane substantially perpendicular to the axis of the stem 312. The tube 305 fits over the stem 312 and includes mounting holes (also not shown) corresponding to the holes in the stem 312. The tube 305 is secured to the stem 312 by a fastener 316 or similar means passing through the holes. When the tube 305 is secured to the stem 312, the lever 302 is pivotable about the pivot 315 as generally indicated by arrow 309 in FIGS. 2 and 4. Further, the slotted holes in the stem 312 allow the lever 302 to pivot over a limited arc 313 relative to the axis of the stationary stem 312. Accordingly, the lever 302 pivots about the axes of both the shaft 308 and the stem 312.

Spanning between the control system 300 and each drive mechanism 109 is a control rod 318. At a first end, each control rod 318 couples to the respective drive mechanism 109 while the second or opposite end pivotally couples to one end 306 of the upper control lever 302 at a pivot joint 307 as generally shown in FIG. 2.

Axial displacement of the control rod 318 in a first direction 318′ (towards the mower 100) engages the drive mechanism 109, delivering power to the respective traction wheel 108. Displacement of the rod 318 in a second, opposite direction 318″ (towards the hand rest 122) disengages the drive mechanism 109. Further displacement of the rod 318 in the second direction engages a brake (not shown) on the respective wheel 108.

The pivot 307 allows translation of pivotal movement of either the upper or lower control levers 302, 310 into axial displacement of the control rods 318. For example, with reference to FIG. 2, the upper control lever 302 is shown in a neutral position. By moving the lever 302 in the direction 309 to an engaged or operating position, the rods 318 move in the first direction 318′ and engage the drive mechanisms 109. When released, the lever 302 is biased to its neutral position, disengaging the drive mechanisms. In addition, by pivoting the upper lever 302 about the stem 312 as generally indicated by 313 in FIG. 2, one control rod 318 is moved in the first direction 318′ independent of the other rod, engaging only one drive mechanism 109 and causing the mower 100 to turn. Once again, when the upper lever 302 is released, it returns to a medial, neutral position in which neither drive mechanism is engaged.

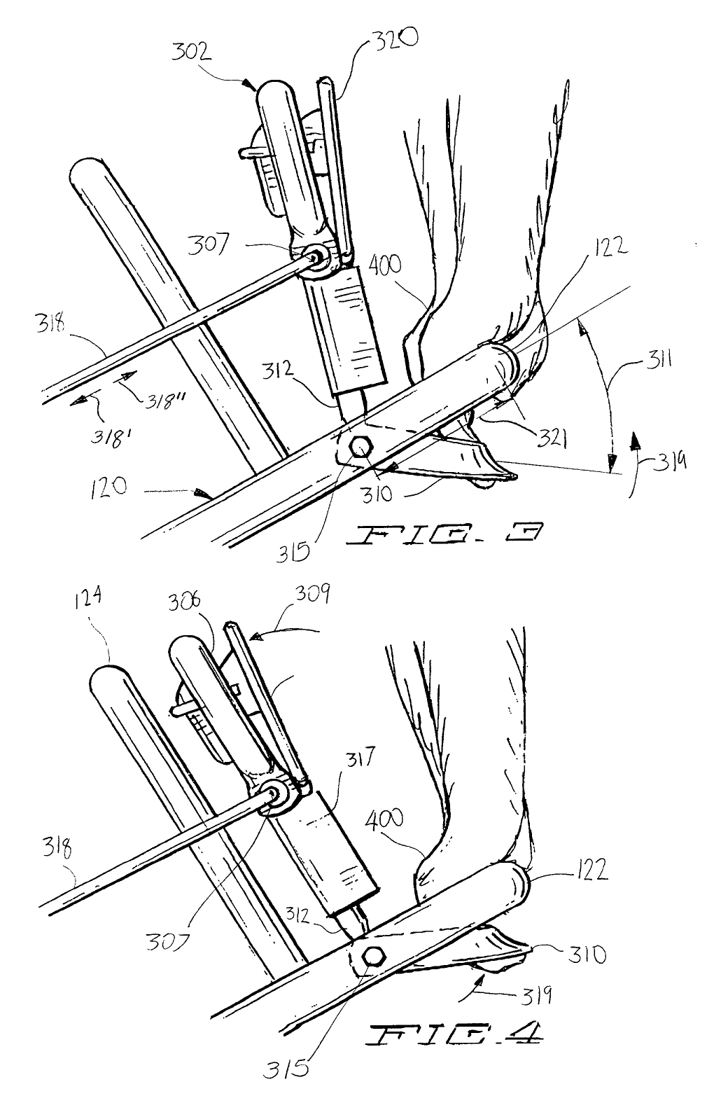

Similarly, movement of the lower lever 310 from a first position (as shown in FIG. 3) in a direction 319 to a second position (as shown in FIG. 4) causes the upper control lever 302 to move in the direction 309 from the neutral position to the engaged position. This once again moves the control rods 318 in the first direction 318′ and engages the drive mechanisms 109. Upon release, the lower lever 310 returns to the first position under the biasing force of the upper lever 302 as the latter returns to its neutral position.

Referring still to FIGS. 3 and 4, attention is directed to the lower lever 310. From FIG. 3, the lower lever 310, shown in the first position, forms an acute angle 311 with the handle 120 when viewed from the side. When the lower lever 310 is moved to the second position, it is substantially adjacent to the hand grip 122. Stated alternatively, the lower lever 310, when in the second position, is located such that it can be comfortably held in close proximity to the hand grip 122 by an average operator as shown in FIG. 4. While the lever 310 is shown in the figure as slightly offset from the hand grip 122 (when in the second position), other embodiments in which the lower lever contacts the hand grip are also possible.

The angle 311 is primarily selected to provide the operator with convenient access to the lever 310 with one or both hands 400 while the one or both hands are resting on the hand grip 122. That is, the fingers of either hand may reach and engage the lever 310 as shown in FIGS. 3 and 4. In one embodiment, the angle 311 is approximately 40 degrees. However, the actual angle 311 can vary depending on the relative distance 321 (see FIG. 3) between the pivot 315 and the hand grip 122. For instance, if the distance 321 is relatively great, a lesser angle is provided. If the distance 321 is relatively small, a greater angle 311 is acceptable. In any event though, the angle 311 should position the lower lever 310 within reach of the operator's hand as generally shown in FIG. 3. For reasons that will become apparent, this offers a significant advantage over current control systems.

In one embodiment, a parking lever 317 is secured to the tube 305 by the fastener 316. The lever 317 is folded against the tube 305 as shown in FIG. 2 when not in use. When engaged, the parking lever is pivoted about the fastener 316 such that it contacts the hand rest 124. In this position, the lever 302 (and thus the lower lever 310) is immobilized, preventing engagement of the traction wheels 108.

Other features are also incorporated into the control system 300. For example, a blade control bail 320 as shown in FIG. 3 is provided. The blade control bail 320 completes an electric circuit that permits the cutting blades to operate. The blade control bail is engaged by pushing the bail 320 towards the control lever 302. The bail 320 typically works in conjunction with a blade control switch (not shown) such that the cutting blades are only activated by engaging both the bail 320 and the switch. Once engaged, the blades remain engaged until the bail 320 is released.

The dual lever (upper 302 and lower 310) control system permits intuitive operation in conformance with industry standards. During forward operation, the operator typically uses the upper lever 302 to engage the drive system 101 and propel the mower 100 forward (assuming the gear selector is in a forward gear). All steering is also accomplished via manipulation of the upper lever 302 as explained above. To maintain this intuitive control in reverse, the lower lever 310 is provided. By pulling the lower lever 310 toward the hand grip 122 as generally shown in FIG. 4, the drive system 101 is engaged and the mower 100 is propelled backwards (assuming the gear selector is in a reverse gear). Accordingly, the control system 300 permits the operator to equate control lever displacement with mower movement in conformance with industry standards.

Having described an exemplary embodiment of the control system 300 as embodied in the mower 100, attention is now focused on its operation. The purpose of this description is to permit someone of skill in the art to use the mower 100. Accordingly, steps that are not critical or those that are well known in the art have been omitted for the sake of simplicity. The reader is also reminded that, while described in a particular order, steps may be rearranged to some degree to better accommodate particular operating or safety protocols. In addition, steps may be modified to accommodate use with other mower configurations. Furthermore, although the method is described in terms of a mid-size mower, other machines or other ground-engaging apparatuses to which the control system of the present invention could be applied (e.g., dethatchers, aerators, snow throwers, walk-behind skid steer loaders, etc.) are also within the scope of the invention.

After starting the engine 104 by conventional methods (e.g., pull start recoil or electric start), the engine speed is adjusted by manipulation of the throttle lever (not shown) located on the handle 120. Other switches and levers (engine on/off, blade control) that are not particularly pertinent to an understanding of the invention are not herein discussed.

The gear selector (not shown) is then moved to the desired forward gear and the drive system 101 is engaged by pushing the upper lever 302 forward to the engaged or operating position (i.e., toward the hand rest 124). When the upper lever 302 is pushed forward (i.e., pivoted about the pivot 315), the two control rods 318 move in the first direction 318′ and engage both drive mechanisms 109, driving the wheels 108 in a forward direction. To alleviate operator fatigue, the operator may hold or pinch the lever 302 against the rest 124.

To stop the mower 100, the upper lever 302 is released. The control rods 318 and control system 101 are biased to the neutral position so that, when the control lever 302 (or 310) is released, the drive mechanism 109 disengages and the control lever 302 returns to its neutral position. To stop more quickly, the operator pulls back on the control lever 302 to not only disengage the drive mechanisms 109 but also to apply the brakes.

To turn the mower 100, the operator pivots the control lever 302 about the central stem 312. By pivoting the lever 302 in this way, only one end 306 of the lever 302 is pushed in the first direction 318′. Thus, only the control rod 318 attached to the most forward end 306 engages its respective drive mechanism 109. The single engaged traction wheel 108 then rotates under driving power, causing the mower 100 to turn toward the opposite side.

To move the mower 100 in reverse, the gear selector is placed in a reverse gear. The drive system 101 is then engaged by pulling the lower lever 310 towards the hand grip 122. As explained above, movement of the lower lever 310 towards the hand grip 122 causes the upper lever 302 to move forward and equally engage both drive mechanisms 109. When reverse gear is selected, engagement of the drive mechanisms 109 drives the wheels 108 in the reverse direction.

The proximity of the lower lever 310 to the hand grip 122 allows the operator to move the lever 310 from its first position (see FIG. 3) to its second position (see FIG. 4) without removing either hand from the hand grip 122. Similarly, the operator can engage the lever 310 with only one hand without removing that hand from the grip 122. This one-handed operation is of particular benefit during reverse operation as the operator can easily rotate his or her body to more conveniently see what is directly behind the mower 100.

Another advantage of the lever 310 of the present invention is realized during obstruction traversal. Obstacles such as curbs are frequently encountered during transport of the mower 100 from site to site. While it is generally perceived to be easier to back the mid-sized mower 100 over such obstructions, the mower still requires significant operator assistance in order to “climb” the curb. Specifically, the operator must typically apply an upward (lifting) or downward) (pushing) force to the handle 120 to assist the mower in traversing the curb. At the same time, the operator must also ensure the drive system 101 remains engaged so that driving power is continuously supplied to both wheels 108.

With a conventional mid-size mower control system 600 as shown in FIG. 6, a reverse bail 602 is supplied for reverse operation. However, unlike the present invention, this reverse bail is not intended to be accessible while the hands are located on hand grip 604. Rather, engagement of the bail 602 requires that the operator grasp the bail separately as shown in FIG. 6. With one hand 400L on the reverse bail 602, only one hand 400R remains on the handle 604. While more than adequate for normal mower control, it is awkward to apply a lifting or pushing force to the handle when the hands are located in this non-symmetric position. Further, the need to apply a constant upward force on the bail 602 (to keep the traction wheels engaged) generally restricts the application of a downward force by the hand 400L holding the bail 602. Still further, it is ergonomically inconvenient to apply a lifting force to the handle when one hand 400L is positioned on the reverse bail 602 and the other hand 400R is positioned on the handle 604 as shown.

Unlike the system 600, the lower lever 310 of the present invention is instead positioned to permit the operator to draw the lever to the hand grips 122 without removing either hand therefrom as illustrated in FIGS. 3 and 4. As such, a symmetric, even grip is maintained on the combined hand grip 122 and lower lever 310 during operation as shown in FIG. 4. Thus, the operator may easily apply upward and downward as well as forward, backward and transverse forces to the hand grip 122.

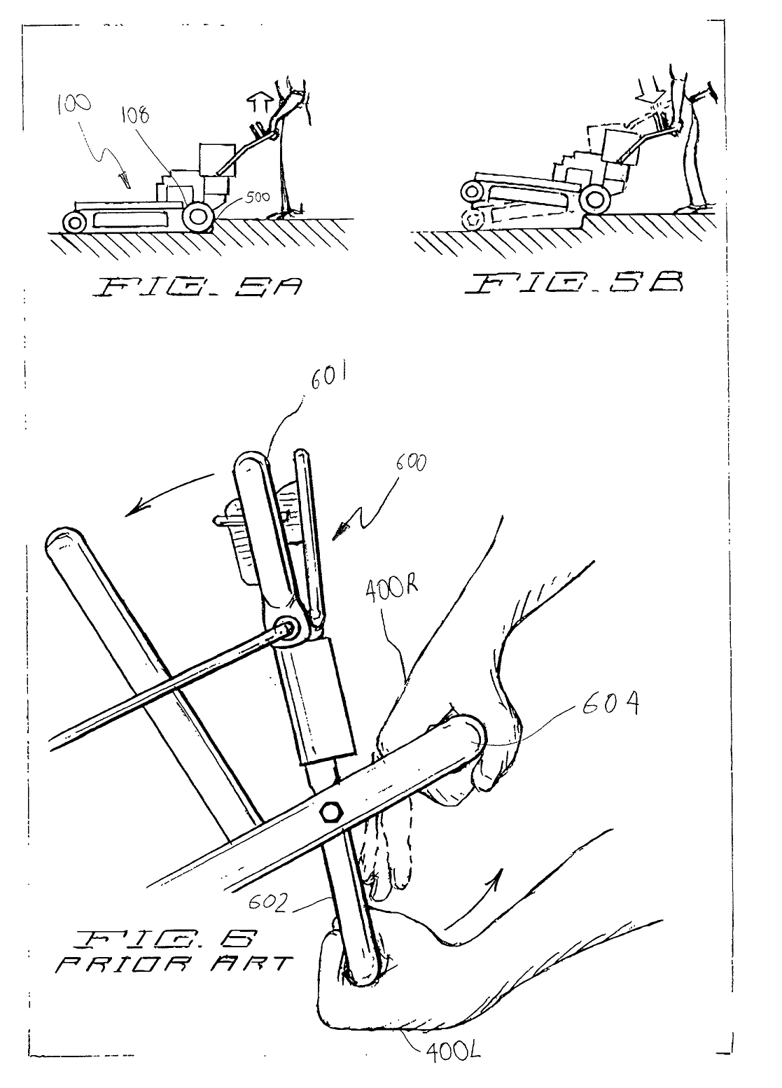

Accordingly, when traversing a curb in reverse as shown in FIGS. 5A and 5B, the control system 300 of the present invention permits the operator to more easily lift and/or push against the handle 120. After disengaging the blades, the lower lever 310 is moved to its second position by grasping the lower lever 310 and pulling it to the hand grip 122 as discussed herein. The mower 100 is then backed until the wheels 108 contact the curb 500 as shown in FIG. 5A. At this point, the operator lifts against the hand grip 122 while holding the lower lever thereto as shown in FIG. 4. Once the mower climbs the curb 500, the operator may push downwardly to raise the cutting unit 112 and caster wheels 114 for passage over the curb as shown in FIG. 5B. This downward force is applied without changing hand positions. Accordingly, operator assistance in movement of the mower 100 over the ground obstruction 500 is greatly simplified with the control system 300 of the present invention.

Although not illustrated, the method works equally well for forward traversal. With the blades disengaged, the operator can drive the mower forwardly until the caster wheels are adjacent to the curb. With the gear selector in a forward gear, the operator engages the drive mechanisms 109 in the forward direction by pulling the lower lever 310 to the hand grip 122. Using the lower lever 310 for forward movement permits the operator to maintain even, forward travel without unintentionally pivoting the T-bar and causing a turn. When the caster wheels 114 contact the curb, the handle 120 is pushed down to lift the front end of the mower over the curb. The mower is then driven forward until the traction wheels 108 contact the curb at which point the operator applies an upward force to assist the wheels 108 in climbing the curb. The transition from pushing down on the handle to pulling up is accomplished without changing hand positions.

Advantageously, the control system of the present invention provides improved operator control, particularly for reverse operation and curb traversal. By providing a lower lever which is conveniently accessible with one or both hands while the one or both hands are on the mower hand grip, the operator is able to maintain engagement of the drive system while keeping a secure grip on the hand grip. Accordingly, the operator can more easily provide assistance to the mower during obstacle traversal. Furthermore, the geometry of the lower lever permits the operator to hold the lever engaged with one hand, therefore permitting the operator to swivel his or her body during reverse operation. Additionally, the present invention allows straight line, forward travel by permitting forward engagement of the drive system with the lower lever.

Preferred embodiments of the present invention are described above. Those skilled in the art will recognize that many embodiments are possible within the scope of the invention. Variations, modifications, and combinations of the various parts and assemblies can certainly be made and still fall within the scope of the invention. Thus, the invention is limited only by the following claims, and equivalents thereto.

What is claimed is:

1. An operator control system for use with a self-propelled machine where the machine has a prime mover selectively coupled to two or more ground-engaging traction wheels, the system comprising:
a handle attached to the machine and extending in a generally rearwardly direction, the handle forming a transverse hand grip, wherein the hand grip is adapted to receive one or both hands of an operator;
a pivot member transversely and pivotally mounted to the handle, the pivot member having a pivot axis substantially parallel with the hand grip;
a first lever positioned above the handle, the first lever having a downwardly extending connecting member operatively coupled to the pivot member, the first lever being pivotable about the pivot axis between a neutral position and an operating position; and
a second lever attached to the pivot member and extending downwardly and away therefrom, the second lever being movable from a first position in which the second lever extends at an acute angle from the handle, to a second position in which the second lever is substantially adjacent to the hand grip, wherein the operator may manipulate the second lever between the first and second positions with the one or both hands while the one or both hands are positioned on the hand grip.

2. The system of claim 1 wherein the second lever is adapted to be grasped and held substantially adjacent to the hand grip by the one or both hands when the second lever is in the second position.

3. The system of claim 1 wherein the prime mover is coupled to the ground-engaging traction wheels when the first lever is in the operating position.

4. The system of claim 1 wherein the prime mover is coupled to the ground engaging traction wheels when the second lever is in the second position.

5. In a self-propelled, walk-behind lawn mower having: a frame supported by two or more traction wheels; and a prime mover attached to the frame, the prime mover adapted to selectively deliver power to the traction wheels, an operator control system comprising:
a handle attached to the mower and extending in a generally rearwardly direction, the handle forming a transverse hand grip, wherein the hand grip is adapted to receive one or both hands of an operator;
a pivot member transversely and pivotally mounted to the handle, the pivot member having a pivot axis generally parallel with the hand grip;
a first lever positioned above the handle, the first lever having a downwardly extending connecting member operatively coupled to the pivot member, the first lever being pivotable about the pivot axis between a neutral position and an operating position; and
a second lever attached to the pivot member and extending downwardly and away therefrom, the second lever being movable from a first position in which the second lever extends at an acute angle from the handle, to a second position in which the second lever is substantially adjacent to the hand grip, wherein the operator may manipulate the second lever between the first and second positions with the one or both hands while the one or both hands are positioned on the hand grip.

6. The system of claim 5 wherein the second lever is adapted to be grasped and held substantially adjacent to the hand grip by the one or both hands when the second lever is in the second position.

7. The system of claim 5 wherein the second lever moves to the first position when the first lever is moved to the neutral position and the second lever moves to the second position when the first lever is moved to the operating position.

8. The system of claim 5 wherein the first lever moves to the neutral position when the second lever is moved to the first position and the first lever moves to the operating position when the second lever is moved to the second position.

9. The system of claim 5 wherein the first lever is biased to the neutral position.

10. The system of claim 5 wherein the first lever further comprises:
a first transverse end coupled to a first drive means, the first drive means adapted for delivering power from the prime mover to a first wheel; and
a second transverse end coupled to a second drive means, the second drive means adapted for delivering power from the prime mover to a second wheel.

11. The system of claim 10 wherein the prime mover selectively delivers power to the first and second drive means when the first lever is in the operating position.

12. The system of claim 10 wherein the prime mover selectively delivers power to the first and second drive means when the second lever is in the second position.

13. The system of claim 10 wherein the first lever is pivotable about a second pivot axis coaxial with the connecting member such that when the first lever is pivoted in a first direction about the second pivot axis, the first drive means is engaged and when the first lever is pivoted in a second direction about the second pivot axis, the second drive means is engaged.

14. The system of claim 13 wherein the first lever is biased about the second pivot axis to a medial position.

15. The system of claim 5 wherein the acute angle is between approximately 35 degrees and 45 degrees.

16. The system of claim 5 wherein the acute angle is approximately 40 degrees.

17. A method for transporting a self-propelled, walk-behind machine rearwardly over a ground obstruction, the machine having a prime mover selectively coupled to two or more traction wheels, the method comprising:
providing an operator control system having:
a handle attached to the machine and extending in a generally upwardly and rearwardly direction, the handle forming a transverse hand grip, wherein the hand grip is adapted to receive one or both hands of an operator;
a pivot member transversely and pivotally mounted to the handle, the pivot member having a pivot axis generally parallel with the hand grip;
a first lever positioned above the handle, the first lever having a downwardly extending connecting member operatively coupled to the pivot member; and
a second lever attached to the pivot member and extending downwardly and away therefrom, the second lever being movable from a first position in which the second lever extends at an acute angle from the handle, to a second position in which the second lever is in close proximity to the hand grip, wherein the operator may manipulate the second lever between the first and second positions with the one or both hands while the one or both hands are positioned on the hand grip;
grasping the hand grip and squeezing the second lever thereto, thereby engaging the prime mover with the traction wheels to propel the machine in reverse;
contacting the obstruction with the traction wheels; and
lifting upwardly on the hand grip and the second lever with the one or both hands to assist the machine as it traverses the obstruction.

18. The method of claim 17 further comprising pushing down on the hand grip while squeezing the second lever thereto with the one or both hands to further assist the machine as it traverses the obstruction.

19. A method for transporting a self-propelled, walk-behind machine in a forward or reverse direction, the machine having a prime mover selectively coupled to two or more traction wheels, the method comprising:
providing an operator control system having:
a handle attached to the machine and extending in a generally rearwardly direction, the handle forming a hand grip, wherein the hand grip is adapted to receive one or both hands of an operator;
a pivot member transversely and pivotally mounted to the handle, the pivot member having a pivot axis generally parallel with the hand grip;
a first lever positioned above the handle, the first lever having a downwardly extending connecting member operatively coupled to the pivot member; and
a second lever attached to the pivot member and extending downwardly and away therefrom, the second lever being movable from a first position in which the second lever extends at an acute angle from the handle, to a second position in which the second lever is in close proximity to the hand grip, wherein the operator may manipulate the second lever between the first and second positions with the one or both hands while the one or both hands are positioned on the hand grip;
grasping the hand grip and the second lever and squeezing the second lever to the hand grip, thereby pivoting the second lever from the first to the second position, wherein movement of the second lever to the second position operatively couples the prime mover to the traction wheels.

20. The method of claim 19 further comprising pushing down with the one or both hands on the hand grip while squeezing the second lever thereto to assist the machine in traversing an obstruction.

21. The method of claim 19 further comprising pulling up with the one or both hands on the hand grip while squeezing the second lever thereto to assist the machine in traversing an obstruction.
